(19) United States
(12) Patent Application Publication
(10) Pub. No.: US 2005/0149753 A1
(43) Pub. Date: Jul. 7, 2005

(54) Apparatus, system, and method for validating interface addresses

(76) Inventors: Daryl Carvis Cromer, Apex, NC (US); Howard Jeffrey Locker, Cary, NC (US); Marc Richard Pamley, Durham, NC (US); Randall Scott Springfield, Chapel Hill, NC (US)

Correspondence Address: KUNZLER & ASSOCIATES, 8 EAST BROADWAY, SUITE 600, SALT LAKE CITY, UT, 84111, US

(21) Appl. No.: 10/748,063

(22) Filed: Dec. 30, 2003

(51) Int. Cl. H04L 9/00

(52) U.S. Cl. 713/201

(57) ABSTRACT

An apparatus, system and method of verifying an interface address are provided. A communication device is connected to a network. The apparatus, system and method query the communication device for an interface address identifying the communication device to the network. The apparatus, system, and method further receive the interface address from the communication device and identify an invalid interface address. In one embodiment, the interface address is invalid if it is outside of a specified interface address range. The apparatus, system, and method mitigate the invalid interface address. In one embodiment, the apparatus, system, and method mitigate the invalid interface address by deactivating the network.

### BACKGROUND OF THE INVENTION

1. Field of the Invention

The invention relates to verifying interface addresses and more particularly, to identifying valid interface device addresses on a network.

2. Description of the Related Art

Networks are often used to enable communications between two or more data processing devices such as computers, servers, data storage devices, routers, and printers. The data processing device communicates over the network through a communication module. The communication module may be a discrete device such as a network interface card (“NIC”) or an integral part of the data processing device.

Two or more communication modules exchange data over the network. The data may include software instructions, information, and commands. A communication module is typically identified by a unique interface address. The interface address is used to route data to the proper communication module. In addition, the interface address may also identify the source of communicated data. One example of an interface address is the media access controller (“MAC”) address defined by specification 802.3 of the Institute for Electrical and Electronic Engineers (“IEEE 802.3”) for Ethernet networks.

The interface address for a communication module may be invalid. For example, on many networks an interface address of binary zeros or ones is invalid. An interface address of binary zeros or binary ones may result from the communication module being inoperative or improperly connected to the network.

Duplicate interface addresses in two communication modules are also invalid because neither address is unique. A manufacturer is often assigned ranges of interface addresses for communication modules. If a first communication module's interface address is outside of the manufacturer's assigned interface address range, the interface address may be invalid because a second communication module may share the interface address. Interfaces address may also be duplicated during manufacturing, creating invalid interface addresses.

An invalid interface address may slow or even disable a network. For example, an invalid address may generate excessive network traffic to the invalid address. Invalid duplicate network addresses may misdirect data, comprising network integrity and even forcing the termination of network functions. The cost of slowing or disabling network functions can be expensive. In addition, determining that a network problem is caused by invalid interface addresses can be time-consuming.

What is needed are a process, apparatus, and system that validate the interface addresses of communication modules. Beneficially, such a process, apparatus, and system would reduce network failures resulting from invalid interface addresses.

### SUMMARY OF THE INVENTION

The present invention has been developed in response to the present state of the art, and in particular, in response to the problems and needs in the art that have not yet been fully solved by currently available data processing devices. Accordingly, the present invention has been developed to provide a process, apparatus, and system for validating interface addresses that overcome many or all of the above-discussed shortcomings in the art.

The apparatus for verifying an interface address is provided with a logic unit containing a plurality of modules configured to functionally execute the necessary steps of querying an interface address, receiving the interface address, identifying an invalid interface address, and mitigating the invalid interface address. These modules in the described embodiments include a communication module and a logic module.

The communication module communicates with a network. In addition, the communication module is identified on the network by an interface address. In one embodiment, the communication module is Ethernet compatible and the interface address is a media access control (“MAC”) address. The logic module queries the communication module for the interface address of the communication module. The communication module communicates the interface address to the logic module in response to the logic module's query.

The logic module receives the interface address. In addition, the logic module determined whether the interface address is invalid. In one embodiment, the interface address is determined to be invalid if the interface address falls outside of a specified interface address range. In a certain embodiment, the specified interface address range may be assigned to one or more devices of the same configuration. In an alternate embodiment, the specified interface address range may be assigned to a manufacturer. In one embodiment, the interface address is determined to be invalid if the interface address is a specified error value. In a certain embodiment, an interface address of binary zeros is a specified error value.

The logic module is configured to mitigate the invalid interface address. In one embodiment, the logic module isolates the communication module from the network to mitigate the invalid interface address. In an alternate embodiment, the logic module deactivates the network to mitigate the invalid interface address.

A system of the present invention is also presented for verifying an interface address. The system may be embodied in a data processing network. In particular, the system, in one embodiment, includes a network, an interface device, and a verification device. The interface device and the verification device communicate with the network.

The interface device is identified on the network by an interface address. The verification device queries the interface address of the interface device through the network. The interface device communicates the interface address to the verification device in response to the verification device's query. The verification device receives the interface address. In addition, the verification device determines whether an interface address is invalid. The verification device mitigates the invalid interface address. In one embodiment, the verification device deactivates the network to mitigate the invalid interface address.

A process of the present invention is also presented for verifying an interface address. The process in the disclosed embodiments substantially includes the steps necessary to carry out the functions presented above with respect to the operation of the described apparatus and system. In one embodiment, the process includes querying an interface address, receiving the interface address, determines whether an interface address is invalid, and mitigating the invalid interface address.

The process queries an interface address. In addition, the process receives the interface address. The process determines whether the interface address is invalid. In one embodiment, the interface address is determined to be invalid if the interface address is outside of a specified interface address range. In an alternate embodiment, the interface address is determined to be invalid if the interface address is a specified error value.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention verifies that an interface address is valid. In addition the present invention mitigates the damage to a network from an invalid interface address. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a data processing device in accordance with the present invention;

FIG. 2 is a block diagram illustrating one embodiment of an interface device of the present invention;

FIG. 3 is a block diagram illustrating one embodiment of a data processing network in accordance with the present invention;

FIG. 4 is a block diagram illustrating one embodiment of a data processing device 400 of the present invention;

FIG. 5 is a flow chart illustrating one embodiment of a verification criteria programming method of the present invention;

FIG. 6 is a flow chart illustrating one embodiment of an initialization method of the present invention; and

FIG. 7 is a flow chart diagram illustrating one embodiment of a verification method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

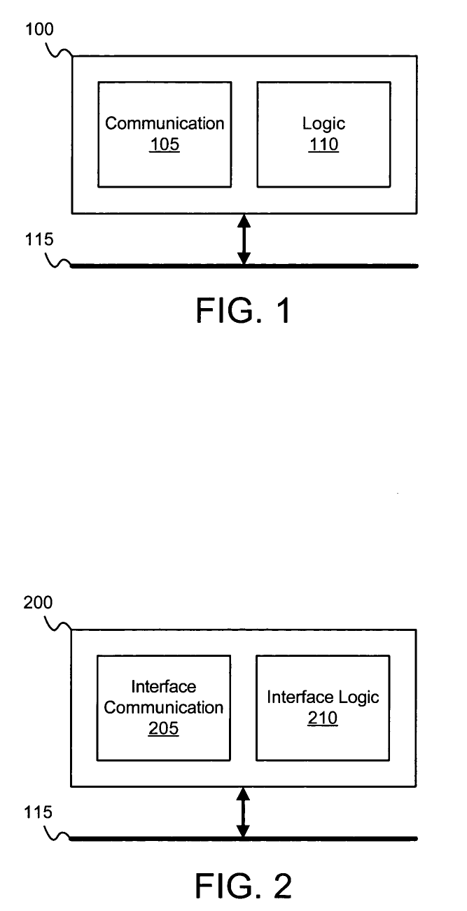

FIG. 1 is a block diagram illustrating one embodiment of a data processing device 100 of the present invention. The data processing device 100 verifies a valid interface address. In the depicted embodiment, the data processing device 100 includes a communication module 105 and a logic module 110. Although for simplicity the data processing device 100 is depicted with one communication module 105, any number of communication modules 105 may be employed.

The communication module 105 communicates with a network 115. The communication module 105 is identified on the network 115 by an interface address. In one embodiment, the interface address is an Ethernet media access control (“MAC”) address. The logic module 110 queries the interface address of the communication module 105. The logic module 110 may be hardware, firmware, or software. The communication module 105 communicates the interface address to logic module 110. The logic module 110 receives the interface address.

The logic module 110 determines whether the interface address is invalid. In one embodiment, the interface address is determined to be invalid if the interface address is outside of a specified interface address range. The specified interface address range may be specified for one or more devices of the same type. In a certain embodiment, the specified interface address range is assigned to a manufacturer. In one embodiment, the logic module 110 is programmed with the specified interface address range.

In an alternate embodiment, the interface address is determined to be invalid if the interface address is a specified error value. The specified error value maybe the interface address of all binary zeros. In a certain embodiment, the specified error value is the interface of all binary ones.

In one embodiment, the communication module 105 may fail to communicate the interface address to the logic module 110 in response to the logic module's 110 query. The logic module 110 may determine that the interface address of the communication module 105 as invalid if the logic module 110 does not receive the interface address within a specified time interval.

The logic module 110 mitigates the invalid interface address if the logic module 110 determines that the interface address is invalid. In one embodiment, the logic module 110 deactivates the network 115. In an alternate embodiment, the logic module 110 isolates the communication module 105 from the network. The logic module 110 may isolate the communication module 105 by deactivating the communication module 105.

The data processing device 100 is configured in one embodiment to validate the interface address of the communication module 105 and mitigate the invalid interface address. Validating the interface address protects the data processing device 100 from damaging the network 115 with the invalid interface address.

FIG. 2 is a block diagram illustrating one embodiment of an interface device 200 of the present invention. The interface device 200 communicates an interface address in response to a query. In addition, the interface device 200 may be isolated from a network if the interface device 200 has an invalid interface address. The interface device 200 includes an interface communication module 205 and an interface logic module 210. Although the interface device 200 is depicted with one interface communication module 205, the interface device may employ any number of interface communication modules 205.

The interface communication module 205 communicates with a network 115. The interface communication module 205 is further identified on the network 115 by an interface address. The interface communication module 205 receives a query from the network 115. The query may be communicated from a verification device. In one embodiment, the verification device is the data processing device 100 of FIG. 1. The interface communication module 205 communicates the interface address in response to the query.

The interface address of the interface communication 205 may be invalid. In one embodiment, the interface communication module 210 receives a mitigation command. The interface logic module 210 may isolate the communication module 210 from the network 115 in response to the mitigation command.

The interface device 200 communicates the interface address in response to the query. The interface device 200 may further isolate the interface device 200 from the network 115 in response the mitigation command. Isolating the interface device 200 from the network 115 may protect the network 115 from damage resulting from the invalid interface address.

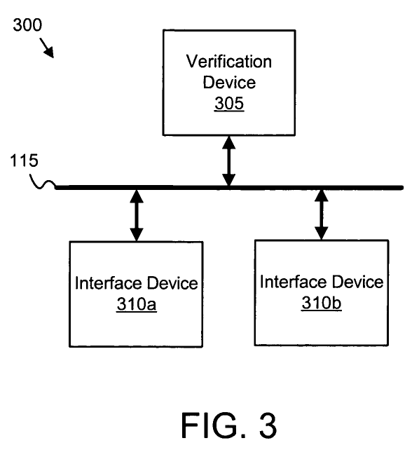

FIG. 3 is a block diagram illustrating one embodiment of a data processing network 300 of the present invention. The data processing network 300 verifies one or more interface addresses. The data processing network 300 includes a verification device 305, a network 115, and one or more interface devices 310. Although for simplicity the data processing network 300 is depicted with one verification device 305 and two interface devices 310, the data processing network may include any number of verification devices 305 and any number of interface devices 310.

In one embodiment, the verification device 305 is the data processing device 100 of FIG. 1. In a certain embodiment, the verification device 305 verifies the interface address of the verification device 305. In one embodiment, the verification device 305 verifies the interface address of the interface device 310. The verification 305 device may identify an invalid interface address.

In a certain embodiment, the verification device 305 queries the first interface device 310a and the second interface device 310b. The first verification device 310a and the second verification device 310b communicate interface addresses in response to the query and the verification device 305 receives the interface addresses. The verification device 305 may identify the interface addresses of the first interface device 310a and the second interface device 310b as invalid if the interface addresses of the first interface device 310a and the second interface device 310b are equivalent.

The verification device 305 mitigates the invalid interface address. In one embodiment, the verification device 305 deactivates the network 115 to mitigate the invalid interface address. In an alternate embodiment, the verification device 305 isolates the device with the invalid interface address from the network 115. The data processing network 300 verifies one or more interface addresses, mitigating damage to the network 115 from the invalid interface address.

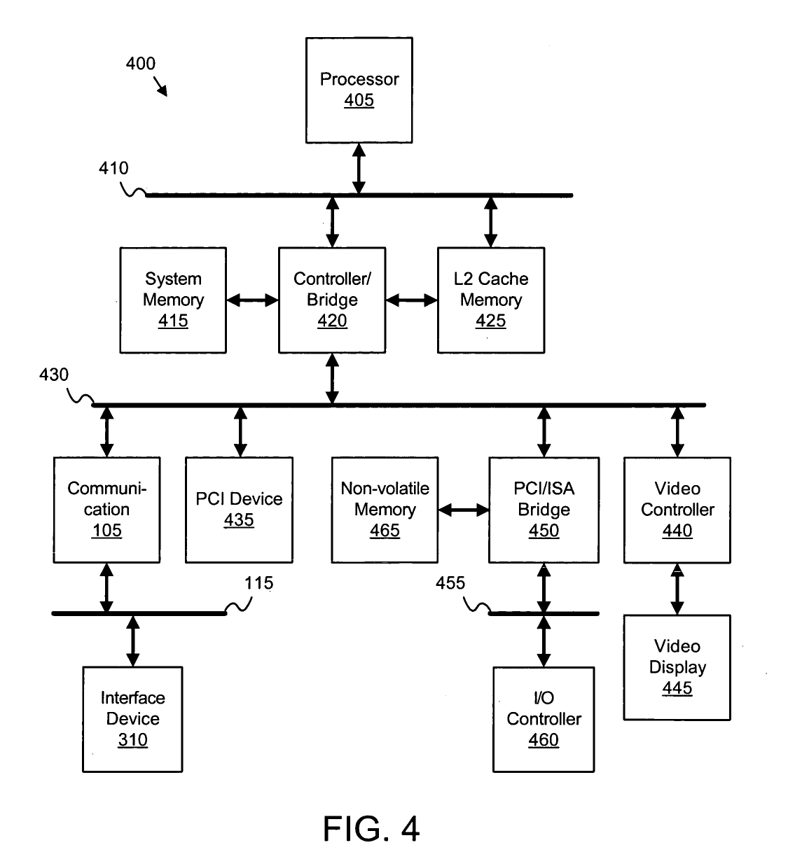

FIG. 4 is a block diagram illustrating one embodiment of a data processing device 400 of the present invention. The data processing device 400 may function as the data processing device 100 in FIG. 1. In addition, the data processing device 400 many function as the verification device 300 in FIG. 3. The data processing device 400 includes a processor module 405, a host bus 410, a system memory module 415, a controller/bridge module 420, a L2 cache memory module 425, a peripheral component interconnect (“PCI”) bus 430, a communication module 105, a network 115, a PCI device 435, a non-volatile memory module 465, a PCI/industry standard architecture (“ISA”) bridge module 450, an ISA bus 455, an input/output (“I/O”) controller module 460, a video controller module 440, and a video display 445.

In one embodiment, the processor module 405, the host bus 410, the system memory module 415, the controller/bridge module 420, and the L2 cache memory module 425 form the logic module 110 of FIG. 1. The processor module 405 communicates through the host bus 410, the controller/bridge module 420, and the PCI bus 430 with the communication module 105. In one embodiment, the communication module 105 is an Ethernet NIC.

The processor module 405 queries the interface address of the communication module 105. In one embodiment, the processor module 405 queries the interface address under the direction of a software process residing in the non-volatile memory 465. In a certain embodiment, the software process is a portion of the basic input/output system (“BIOS”).

The communication module 105 communicates the interface address to the processor module 405. The processor module 405 may identify an invalid interface address. If the interface address is invalid, the processor module 405 mitigates the invalid interface address. In one embodiment, the processor module 405 deactivates the network 115. In an alternate embodiment, the processor module 405 isolates the communication module 105 from the network 115.

In one embodiment, the processor module 405 queries the interface address of the interface device 310 connected to the network 115 through the communication module 105. The interface device 310 may communicate the interface address to the processor module 405 and the processor module 405 may identify an invalid interface address. In a certain embodiment, the processor module 405 mitigates the invalid interface address by commanding the interface device 310 to isolate the interface device 310 from the network 115. In an alternate embodiment, the processor module 405 mitigates the invalid interface address by deactivating the network 115. The data processing device 400 may verify the interface address as the data processing device 100 and as the verification device 300.

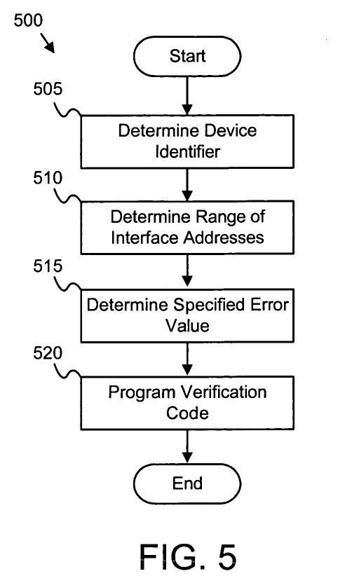

FIG. 5 is a flow chart illustrating one embodiment of a verification criteria programming method 500 of the present invention. The verification criteria programming method 500 programs a verification criterion for verifying the interface address in a verification code. Although for purposes of clarity the verification criteria programming method 500 is depicted in a certain sequential order, execution may be conducted in parallel and not necessarily in the depicted order.

In one embodiment, the verification criteria programming method 500 determines 505 a device identifier. The device identifier may be a product code of a device such as a NIC. The verification criteria programming method 500 determines 510 the range of interface addresses corresponding to the device identifier. In one embodiment, the range of interface addresses is assigned by the manufacturer. The range of interface addresses is the specified interface address range.

In one embodiment, the verification criteria programming method 500 further determines 515 the specified error value. The specified error value may be provided by the manufacturer. The verification criteria programming method 500 programs 520 the verification code, the verification code containing the specified interface address range and the specified error value. In one embodiment, the verification code is programmed to the non-volatile memory 465. The verification criteria programming method 500 programs 520 verification criterion for verifying interface addresses in a verification code.

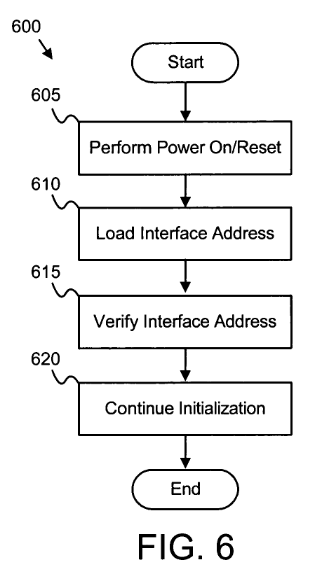

FIG. 6 is a flow chart illustrating one embodiment of an initialization method 600 of the present invention. The initialization method 600 verifies an interface address while initializing the data processing device 100. Although for purposes of clarity the initialization method 600 is depicted in a certain sequential order, execution may be conducted in parallel and not necessarily in the depicted order.

In one embodiment, the initialization method 600 performs 605 a power on operation. In an alternate embodiment, the initialization method 600 performs 605 a reset operation. In a certain embodiment, the initialization method 600 loads 610 an interface address to a communication device 105. The initialization method 600 verifies 615 the interface address. In one embodiment, the initialization method 600 verifies 615 the interface address of the data processing device 100. In an alternate embodiment, the initialization method 600 verifies the interface address of the interface device 200.

In one embodiment, the initialization method 600 continues 620 the initialization. Continuing 620 the initialization may include loading one or more device drivers and loading an operating system. The initialization method 600 verifies the interface address of the data processing device 100 and the interface device 200 during initialization.

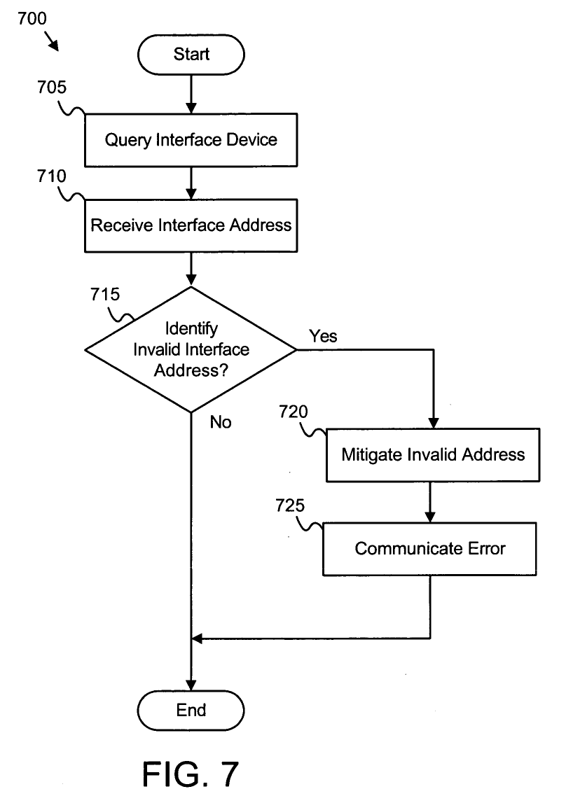

FIG. 7 is a flow chart diagram illustrating one embodiment of a verification method 700 in accordance with the present invention. The verification method 700 verifies an interface address. In one embodiment, the verification method 700 is the verify interface address step 615 of FIG. 6. Although for purposes of clarity the verification method 700 is depicted in a certain sequential order, execution may be conducted in parallel and not necessarily in the depicted order.

The verification method 700 queries 705 the a device. In one embodiment, the verification method 700 queries 705 the communication module 105 of the data processing device 100. In an alternate embodiment, the verification method 700 queries 705 the interface device 200. The verification method 700 receives 710 the interface address. In addition, the verification method 700 identifies 715 an invalid interface address.

In one embodiment, the interface address is invalid provided the interface address is outside of the specified interface address range. In an alternate embodiment, the interface address is invalid provided the interface address is the specified error value. If the verification method 700 identifies 715 the interface address as invalid, the method 700 proceeds to mitigate 720 the invalid address. In addition, if the verification method 700 identifies 715 the interface address as valid, the method 700 terminates.

In one embodiment, the verification method 700 mitigates 720 the invalid interface address by deactivating the network 115. In an alternate embodiment, the verification method 700 mitigates 720 the invalid interface address by isolating the data processing device 100 from the network 115. In a certain embodiment, the verification method 700 mitigates the invalid interface address by isolating the interface device 200 from the network 115. In one embodiment, the verification method 700 communicates an invalid interface address error 725. The verification method 700 may communicate the invalid interface address error to the data processing device 100. The verification method 700 verifies the interface address and mitigates the invalid interface address.

The present invention verifies that an interface address is valid. In addition the present invention mitigates the damage to a network 115 from an invalid interface address. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for verifying an interface address, the apparatus comprising:
a communication module in electrical communication with a network, the communication module configured with an interface address, the communication module further configured to communicate the interface address in response to a query; and
a logic module in electrical communication with the communication module, the logic module configured to query the communication module, and to receive the interface address from the communication module, the logic module further configured to determine whether the interface address is invalid, and to mitigate an invalid interface address.

2. The apparatus of claim 1, wherein the interface address is a media access controller address.

3. The apparatus of claim 1, wherein the interface address is determined to be invalid if the interface address is outside of a specified interface address range.

4. The apparatus of claim 1, wherein the interface address is determined to be invalid if the interface address is a specified error value.

5. The apparatus of claim 1, wherein the interface address is determined to be invalid if the interface address is received after a specified time interval.

6. The apparatus of claim 1, wherein the logic module is configured to mitigate the invalid interface address by isolating the communication module from the network.

7. The apparatus of claim 1, wherein the logic module is configured to mitigate the invalid interface address by deactivating the network.

8. An interface device, the device comprising:
an interface communication module in electrical communication with a network, the communication module configured with an interface address, the communication module also configured to receive a query and to communicate the interface address responsive to the query, the communication module further configured to receive a termination command; and
an interface logic module configured to terminate communications between the communication module and the network responsive to the termination command.

9. The interface device of claim 8, wherein the interface address is a media access controller address and the interface device is an Ethernet device.

10. A system for verifying an interface address, the system comprising:
a network;
an interface device in electrical communication with the network, the interface device configured with an interface address and configured to receive a query and to communicate the interface address responsive to the query; and
a verification device in electrical communication with the network, the verification device configured to communicate the query to the interface device and to receive the interface address from the interface device, the verification device further configured to determine whether the interface address is invalid and to mitigate the invalid interface address.

11. The system of claim 10, wherein in the interface address is a media access controller address and the interface device is an Ethernet device.

12. The system of claim 10, wherein the interface address is determined to be invalid if the interface address is outside of a specified interface address range.

13. The system of claim 10, wherein the interface address is determined to be invalid if the interface address is a specified error value.

14. The system of claim 10, wherein the interface address is determined to be invalid if the interface address is equivalent to a second interface address.

15. The system of claim 10, wherein the verification device is configured to mitigate the invalid interface address by isolating the interface device from the network.

16. A computer readable storage medium comprising computer readable code for verifying an interface address, the computer readable code configured to:
query an interface address;
receive the interface address;
determine whether an interface address is invalid; and
mitigate the invalid interface address.

17. The computer readable storage medium of claim 16, wherein the interface address is a media access control address.

18. The computer readable storage medium of claim 16, wherein the computer readable code is configured to mitigate the invalid interface address by isolating a communication module from a network.

19. The computer readable storage medium of claim 16, wherein the computer readable code is configured to deactivate a network to mitigate the invalid interface address.

20. The computer readable storage medium of claim 16, wherein the computer readable code is configured to determine that the interface address as invalid if the interface address is outside of a specified range.

21. The computer readable storage medium of claim 16, wherein the computer readable code is configured to determine that the interface address is invalid if the interface address is equivalent to a second interface address.

22. The computer readable storage medium of claim 16, wherein the computer readable code is configured to determine that the interface address as invalid if the interface address is a specified error value.

23. The computer readable storage medium of claim 16, wherein the computer readable code is configured to determine that the interface address is invalid if the interface address is received subsequent to a specified time interval.

24. A method for verifying an interface address, the method comprising:
querying an interface address;
receiving the interface address;
determining that an interface address is invalid; and
mitigating the invalid interface address.

25. The method of claim 24, wherein the interface address is a media access control address.

26. The method of claim 24, further comprising mitigating the invalid interface address by isolating a communication module from a network.

27. The method of claim 24, wherein the interface address is determined to be invalid if the interface address is outside of a specified interface address range.

28. The method of claim 24, wherein the interface address is determined to be invalid if the interface address is a specified error value.

29. The method of claim 24, wherein the interface address is determined to be invalid if the interface address is equivalent to a second interface address.

30. An apparatus for verifying an interface address, the apparatus comprising:
means for querying an interface address;
means for receiving the interface address;
means for determining that an interface address is invalid; and
means for mitigating the invalid interface address.
